(19) United States
(12) Patent Application Publication
(10) Pub. No.: US 2015/0158542 A1
(43) Pub. Date: Jun. 11, 2015

(54) VEHICLE ENGINE AND TRANSMISSION FRAME

(71) Applicant: Jesse G. James, Austin, TX (US)

(72) Inventor: Jesse G. James, Austin, TX (US)

(21) Appl. No.: 14/099,980

(22) Filed: Dec. 8, 2013

(51) Int. Cl. B62K 11/04

(52) U.S. Cl. CPC B62K 11/04

(57) ABSTRACT

A vehicle, in particular a motorcycle, has an integrated transmission/engine assembly suspended from a cantilever frame. The frame accommodates a V-Twin motorcycle engine that is disposed over the crank case and transmission housings. The frame has a central vertical post member with a portion that extends forward from central post. The forward extending portion of the frame is disposed over the cylinders and rocker boxes and the engine is mounted to this portion of the frame at the rocker boxes. The frame allows a greater variety of arrangements of the engine, transmission and drive components than does a traditional cradle or cage frame for enhanced performance and styling.

### CROSS-REFERENCE TO RELATED APPLICATIONS

This application is a continuation-in-part of, claims the benefit of and priority from U.S. provisional patent application Ser. No. 61/735,030, filed Dec. 9, 2012 by the same inventor and having the same title, the disclosure of which is incorporated herein by reference.

### TECHNICAL FIELD

This disclosure relates generally to vehicles and more particularly to a frame for suspending an integrated engine/transmission system.

### BACKGROUND

Almost all commercially available motorcycles are driven by conventional gasoline internal combustion engines, but some small scooter-type models use an electric motor, and a very small number of diesel models exist.

The displacement is defined as the total volume of air/fuel mixture an engine can draw in during one complete engine cycle. In a piston engine, this is the volume that is swept as the pistons are moved from top dead center to bottom dead center. To the layperson this is the “size” of the engine. Motorcycle engines range from less than 50 cc (cubic centimeters), commonly found in many small scooters, to 5735 cc, a Chevrolet V8 engine, currently used in some cruiser style motorcycles.

Motorcycles have mostly, but not exclusively, been produced with one to four cylinders, and designers have tried virtually every imaginable layout. The most common engine configurations today are the single and twin, the V-twin, the opposed twin (or boxer), and the in-line triple and in-line four. A number of others designs have reached mass production, including the V-4, the flat 6-cylinder, the flat 4-cylinder, the in-line 6-cylinder, and the Wankel engine. Exotic engines, such as a radial piston engine, sometimes appear in custom built motorcycles, and two firms put radial-engined motorcycles into production.

Engines with more cylinders for the same displacement feel smoother to ride. Engines with fewer cylinders are less expensive, lighter, and easier to maintain. Liquid-cooled motorcycles have a radiator which is the primary way their heat is dispersed. Coolant or oil is constantly circulated between this radiator and the cylinder when the engine is running. Air-cooled motorcycles rely on air blowing past fins on the engine case to disperse heat. Liquid-cooled motorcycles have the potential for greater power at a given displacement, tighter tolerances, and longer operating life, whereas air-cooled motorcycles are potentially cheaper to purchase, less mechanically complex and lighter weight.

An air-cooled engine contracts and expands with its wider temperature range, requiring looser tolerances, and giving shorter engine life. The temperature range of an air-cooled two-stroke is even more extreme and component life even shorter than in an air-cooled four-stroke.

As applied to motorcycles, two-stroke engines have some advantages over equivalent four-strokes: they are lighter, mechanically much simpler, and produce more power when operating at their best. But four-stroke engines are cleaner, more reliable, and deliver power over a much broader range of engine speeds.

The frame is typically made from welded aluminium or steel (or alloy) struts, with the rear suspension being an integral component in the design. Carbon fibre, titanium and magnesium are used in a few very expensive custom frames.

The frame typically includes the head tube that holds the front fork and allows it to pivot. Some motorcycles include the engine as a load-bearing (or stressed) member. Although this configuration has been used all through motorcycle history but is now becoming more common.

Oil-in-Frame (OIF) chassis, where the lubricating oil is stored in the frame of the motorcycle, was used for Vincent motorcycles of the 1950s, and for a while during the 1970s on some British motorcycles. It was widely unpopular and generally regarded as a bad idea at the time. Today it is a used on some “thumpers” (single-cylinder four-strokes) that usually have dry-sump lubrication requiring an external oil tank. It has since gained some cachet in the modern custom bike world too because of the space savings it can afford and the reference to an earlier era. At least one manufacturer employed a similar design, now out of production, where the oil was held in the swingarm, while the fuel was held in the frame.

The present disclosure is particularly relevant to Harley-Davidson® motorcycles. The classic Harley-Davidson® engines are V-twin engines, each with a 45° angle between the cylinders. The crankshaft has a single pin, and both pistons are connected to this pin through their connecting rods.

The 45° angle is covered under several United States patents and is an engineering tradeoff that allows a large, high-torque engine in a relatively small space. It causes the cylinders to fire at uneven intervals and produces the choppy “potato-potato” sound so strongly linked to the Harley-Davidson® brand.

To simplify the engine and reduce costs, the V-twin ignition was designed to operate with a single set of points and no distributor. This is known as a dual fire ignition system, causing both spark plugs to fire regardless of which cylinder was on its compression stroke, with the other spark plug firing on its cylinder's exhaust stroke, effectively “wasting a spark”. The exhaust note is basically a throaty growling sound with some popping. The 45° design of the engine thus creates a plug firing sequencing as such: The first cylinder fires, the second (rear) cylinder fires 315° later, then there is a 405° gap until the first cylinder fires again, giving the engine its unique sound.

Harley-Davidson® has used various ignition systems throughout its history—be it the early points and condenser system, (Big Twin up to 1978 and Sportsters 1970 to 1978), magneto ignition system used on 1958 to 1969 Sportsters, early electronic with centrifugal mechanical advance weights, (all models 1978 and a half to 1979), or the late electronic with transistorized ignition control module, more familiarly known as the black box or the brain, (all models 1980 to present).

Starting in 1995, Electronic Fuel Injection (EFI) was introduced as an option. EFI became standard on all Harley-Davidson® motorcycles, including Sportsters, upon the introduction of the 2007 product line.

Motorcycle engines are typically mounted to a cradle- or cage-type frame in which the frame supports the engine block primarily from underneath. Such frames dictate the arrangement of the structures by which the transmission and drive shaft of the vehicle are connected to the engine because the frame itself obstructs access of the structures to the engine.

It would be advantageous, therefor, to provide a vehicle frame for motorcycles in particular whereby the engine is suspended from the frame instead of being cradled by frame. Such a suspension frame provides greater flexibility in the design of the engine itself as well as the arrangement of the drive components of the vehicle such as the transmission and crank case connections over traditional cradle frames.

### SUMMARY

A vehicle, in particular a motorcycle, has an integrated transmission/engine assembly suspended from a cantilever frame. The frame accommodates a V-Twin motorcycle engine that is disposed over the crank case and transmission housings. The frame has a central vertical post member with a portion that extends forward from central post. The forward extending portion of the frame is disposed over the cylinders and rocker boxes and the engine is mounted to this portion of the frame at the rocker boxes. The frame allows a greater variety of arrangements of the engine, transmission and drive components than does a traditional cradle or cage frame for enhanced performance and styling.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a black and white photograph of an exemplary embodiment of an engine mounted to a frame of the present disclosure.

FIG. 2 is a black and white illustration of an exemplary embodiment of a vehicle of the present disclosure.

### DETAILED DESCRIPTION

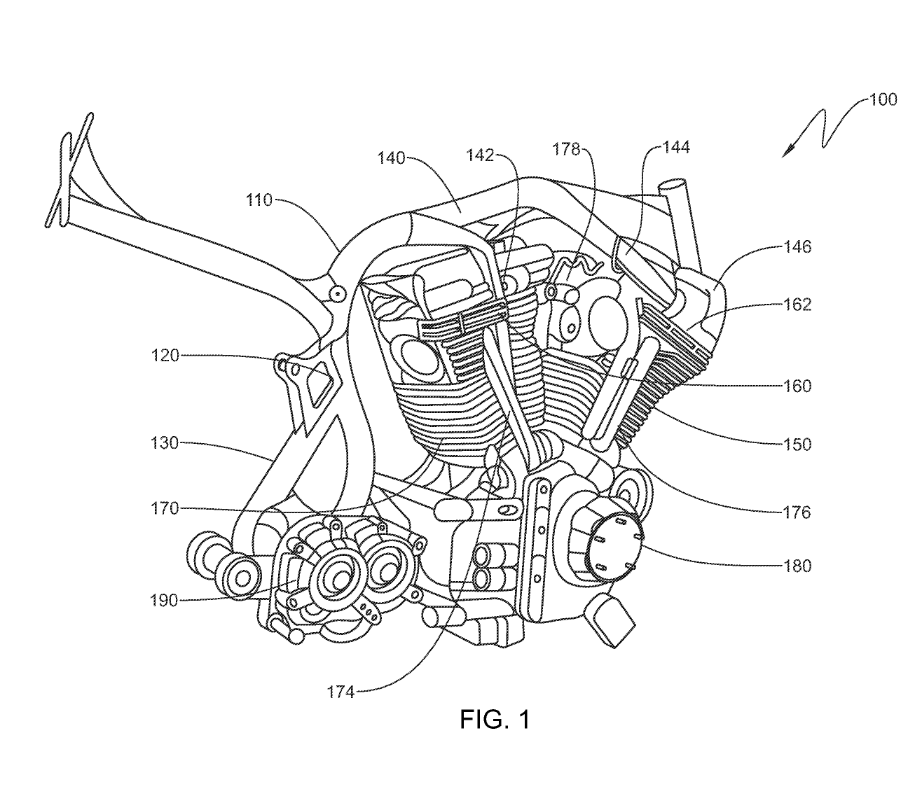

The vehicle of the present disclosure is described with reference to a motorcycle as a non-limiting exemplary embodiment. Referring to FIG. 1 of the drawings, the reference numeral 100 generally designates a frame and engine assembly embodying features of the present disclosure. The system 100 includes a frame 110 having a vertical central post member 120 which arcs toward the back, leg 130 mounted to post 120 and angles downward and back, and cantilever member 140 that extends forward from post 120 over engine 150.

Engine mounting bolt brackets 142, 144 and 146 descend from cantilever member 140 to mount engine 150 to frame 110 at cylinder heads 160, 162. Cylinders 170, 172 are configured in a V-Twin arrangement on crank case 180. Push rods 174, 176 are mounted to cylinders 170, 172, respectively. The EFI system 178 is connected between to the two cylinders 170, 172. Transmission assembly 190 is connected to crank case 180 and to central post member 120 of frame 110.

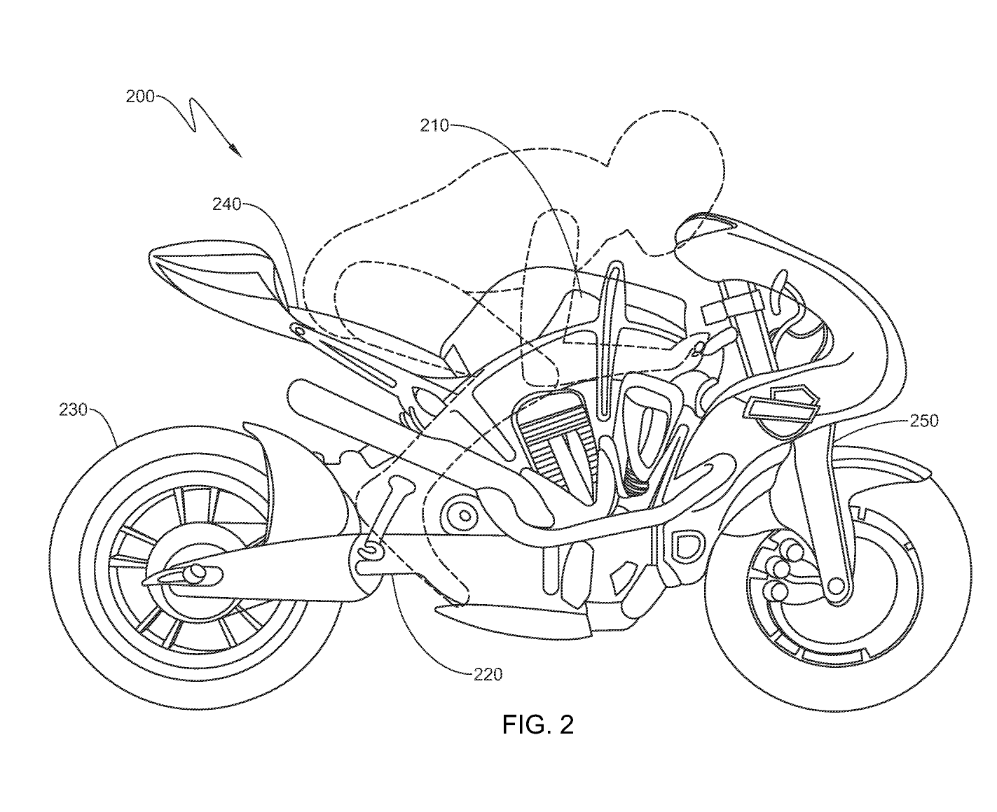

FIG. 2 is an illustration of an exemplary embodiment of a vehicle 200 of the present disclosure. Gas tank 210 is mounted to and in fluid communication with EFI 178 and disposed over cantilever member 140.

Drive shaft housing 220 houses a drive shaft assembly and extends from the transmission and crank case assembly 180, 190 to rear wheel 230. Foot peg 240 is rear-mounted just above housing 220 and in front of rear wheel 230. Driver seat assembly 250 is mounted to central post member 120 on the portion that bends toward to rear of vehicle 200. Front fork 260 is mounted to the front terminus of cantilever frame member 140 and houses the front suspension system.

Specific exemplary embodiments provide a rubber mounted engine to reduce vibration.

Some of the advantages of the present cantilever suspension frame were discussed above. It is worth noting that—Davidson®-type engines are known to be heavier than their counterparts from other manufacturers and therefore would initially seem like an unlikely candidate for an engine mount of the present disclosure. It is testament to the ingenuity of the present design that it performs well even with a relatively heavy Harley-Davidson®-type V-Twin engine.

Many modifications and other embodiments of the vehicle described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A motorcycle engine mounting frame, comprising:
one or more support members;
a cantilever member supported by at least one of the one or more support members; and
one or more engine mounting members extending from the cantilever member, whereby an engine mounted to the engine mounting members is suspended from the cantilever member.

2. A motorcycle engine mounting frame having a front end and a back end, comprising:
a substantially vertical first support member;
a second lower support member extending obliquely from the first support member toward the back end of the frame;
a third upper, substantially horizontal, support member extending from the first support member above the second lower support member and toward the back end of the frame;
a fourth substantially horizontal cantilever member extending from the first support member toward the back end of the frame; and
one or more engine mounting members descending from the cantilever member, whereby an engine mounted to the engine mounting members is suspended from the cantilever member.
